(19) United States
(12) Patent Application Publication
(10) Pub. No.: US 2013/0140884 A1
(43) Pub. Date: Jun. 6, 2013

(54) SIGNAL OUTPUT CIRCUIT

(71) Applicants: Shusuke Furui, Aichi (JP); Toshinori Origane, Aichi (JP); Hiroki Ushiyama, Aichi (JP); Hiroyuki Fujiwara, Aichi (JP)

(72) Inventors: Shusuke Furui, Aichi (JP); Toshinori Origane, Aichi (JP); Hiroki Ushiyama, Aichi (JP); Hiroyuki Fujiwara, Aichi (JP)

(21) Appl. No.: 13/706,716

(22) Filed: Dec. 6, 2012

(30) Foreign Application Priority Data
Dec. 6, 2011 (JP) 2011-266739

(51) Int. Cl. H01H 47/00

(52) U.S. Cl. CPC H01H 47/00
USPC 307/9.1; 307/113

(57) ABSTRACT

Provided is a signal output circuit capable of outputting a normal signal in accordance with an input signal, even when part of the circuit fails. A signal output circuit includes a CPU, a switching circuit, and an output terminal. The switching circuit includes: a first switching unit having a first switching element and a second switching element, and a second switching unit having a third switching element and a fourth switching element. The drain, source, and gate of each of the first and second switching elements are connected to a power source, drains of the third and fourth switching elements, and a first output port of the CPU, respectively. The source and gate of each of the third and fourth switching elements are connected to the output terminal and a second output port of the CPU.

### BACKGROUND OF THE INVENTION

1. TECHNICAL FIELD

One or more embodiments of the present invention relate to a signal output circuit that outputs a predetermined signal in accordance with an input signal.

2. RELATED ART

Signal output circuits of such a type are used in various applications. In an automobile, for example, a signal output circuit outputs respective signals for driving loads, such as those for starting the engine, assisting the brake, and lighting the headlamps. Meanwhile, for a driving device that drives such loads, safety or reliability is in demand. If the load stops being driven due to the malfunction of the circuit, the automobile may be unable to run.

JP 2001-516161 W describes an exemplary circuit arrangement that includes two MOSFET output stages connected in series to each other in order to switch between loads based on a switch-on signal. Each of the MOSFETs is controlled through a logic circuit, and these logic circuits are connected to each other through a connection path in order to mutually monitor the short circuits of the corresponding MOSFETs.

JP 2009-195024 A describes an exemplary driving circuit that drives loads, such as the engine, brake, headlamps, and power windows in an automobile.

Each of JP 2001-173545 A, JP 2004-190606 A, and JP 2005-180386 A describes an exemplary driving circuit that drives a load, such as the starter motor in an automobile.

The starter motor driving circuit described in JP 2001-173545 A includes: a first relay connected in parallel to a starter switch disposed between a battery and a starter motor; a second relay connected in series to the first relay; an energization detection unit that is connected between the first and second relays and that detects actuation state signals for the relays and energized states thereof; and a failure determination unit that determines whether or not the first and second relays fail, based on information from the energization detection unit. Accordingly, even if one of the first and second relays fails, it is possible to reliably control the actuation or stop of the starter motor by controlling the other relay.

The starter motor driving circuit described in JP 2004-190606 A includes: a series connection circuit of a relay circuit and an FET that is provided between a starter motor and a power source; and a CPU that controls the circuit in such a way that when an ignition switch is turned ON, the relay circuit is turned ON and subsequently the FET is turned ON, and when the ignition switch is turned OFF, the FET is turned OFF and subsequently the relay circuit is turned OFF. Accordingly, when the relay circuit is turned ON and OFF, stopping a current from flowing through the series connection circuit can prevent the generation of an arc and the welding of the contact in the relay.

The starter motor driving circuit described in JP 2005-180386 A includes: a first abnormality detection unit that determines whether or not an energization system in the relay coil fails, based on a voltage potential at a terminal for a starter motor when a command of feeding a current to a relay coil is output in order to drive the starter motor; and a second abnormality detection unit that determines whether or not a ground line fails, based on a voltage potential at the terminal for the starter motor while a current is being fed to an electric load for driving an in-automobile apparatus when a command of feeding a current to the relay coil is not output. Accordingly, it is possible to detect a breakage or contact failure in the ground line by using the abnormality detection system in the energization system for the relay coil, and to prevent the malfunction of the starter motor.

### SUMMARY

One or more embodiments of the present invention may provide a signal output circuit capable of outputting a normal signal in accordance with an input signal, even when part of the circuit fails.

In accordance with one aspect of one or more embodiments of the present invention, a signal output circuit includes: a switching circuit including a first switching unit and a second switching unit; a controller controlling the first switching unit and the second switching unit in the switching circuit; and an output terminal outputting a predetermined signal based on an operation of the switching circuit. The first switching unit has a first switching element and a second switching element. The second switching unit has a third switching element and a fourth switching element. Each of the first switching element and the second switching element has a first electrode connected to a power source. Each of the first switching element and the second switching element has a second electrode connected to first electrodes of the third switching element and the fourth switching element. Each of the first switching element and the second switching element has a third electrode connected to a first output port of the controller. Each of the third switching element and the fourth switching element has a second electrode connected to the output terminal. Each of the third switching element and the fourth switching element has a third electrode connected to a second output port of the controller.

With the above configuration, the first switching unit and the second switching unit are connected in series between the power source and the output terminal. Accordingly, even if the first switching unit is short-circuited, as long as the second switching unit is in the normal state, the output terminal outputs a normal signal in accordance with the ON/OFF state of the second switching unit. Likewise, even if the second switching unit is short-circuited, as long as the first switching unit is in the normal state, the output terminal outputs a normal signal in accordance with the ON/OFF state of the first switching unit. Furthermore, each switching unit employs a double structure formed of a pair of switching elements. Therefore, even if one of the switching elements in a switching unit fails and is kept being opened, as long as the other of the switching elements is in the normal state, a normal signal is output from the switching unit. Thus, the above configuration improves the safety and reliability of the signal output circuit driving a load.

In one or more embodiments of the present invention, the controller may include: a first input port that receives a signal of a first switch; and a second input port that receives an external signal from a host device. In addition, the controller may output respective predetermined signals to the first output port and the second output port, based on the signal of the first switch which the first input port has received and the external signal which the second input port has received.

In this case, the signal output circuit may have a configuration in which the signal of the first switch that is input to the first input port is simultaneously input to the third electrodes of the first switching element and the second switching element and the third electrodes of the third switching element and the fourth switching element.

In one or more embodiments of the present invention, the output terminal may be connected to one end of a second switch and the other end of the second switch may be connected to a coil of a relay.

In one or more embodiments of the present invention, an example of the first switch is a starter switch for a vehicle, an example of the second switch is a shift position switch for the vehicle, and an example of the relay is a starter relay for the vehicle.

In one or more embodiments of the present invention, an FET may be used as each switching element. In this case, a drain, source, and gate of the FET constitute the first, second, and third electrodes, respectively.

According to one or more embodiments of the present invention, there is provided a signal output circuit capable of outputting a normal signal in accordance with an input signal even when part of the circuit fails.

### BRIEF DESCRIPTION OF THE DRAWINGS

FIG. 1 is a circuit diagram of a signal output circuit according to one or more embodiments of the present invention;

FIG. 2 is a diagram illustrating a state of the signal output circuit in a non-operational state, and signal waveforms of each unit according to one or more embodiments of the present invention;

FIG. 3 is a diagram illustrating a state of the signal output circuit in a normal operational state, and signal waveforms of each unit according to one or more embodiments of the present invention;

FIG. 4 is a diagram illustrating another state of the signal output circuit in a normal operational state, and signal waveforms of each unit according to one or more embodiments of the present invention;

FIG. 5 is a diagram illustrating a state of the signal output circuit when a first switching unit fails, and signal waveforms of each unit according to one or more embodiments of the present invention;

FIG. 6 is a diagram illustrating another state of the signal output circuit when the first switching unit fails, and signal waveforms of each unit according to one or more embodiments of the present invention;

FIG. 7 is a diagram illustrating a state of the signal output circuit in a non-operational state when the first switching unit fails, and signal waveforms of each unit according to one or more embodiments of the present invention;

FIG. 8 is a diagram illustrating a state of the signal output circuit when a second switching unit fails, and signal waveforms of each unit according to one or more embodiments of the present invention;

FIG. 9 is a diagram illustrating another state of the signal output circuit when the second switching unit fails, and signal waveforms of each unit according to one or more embodiments of the present invention;

FIG. 10 is a diagram illustrating a state of the signal output circuit in a non-operational state when the second switching unit fails, and signal waveforms of each unit according to one or more embodiments of the present invention; and

FIG. 11 is a circuit diagram of a signal output circuit according to one or more embodiments of the present invention.

### DETAILED DESCRIPTION

Hereinafter, embodiments of the present invention will be described with reference to the drawings. In the drawings, the same reference numerals are given to the same or corresponding parts. In embodiments of the invention, numerous specific details are set forth in order to provide a more thorough understanding of the invention. However, it will be apparent to one with ordinary skill in the art that the invention may be practiced without these specific details. In other instances, well-known features have not been described in detail to avoid obscuring the invention

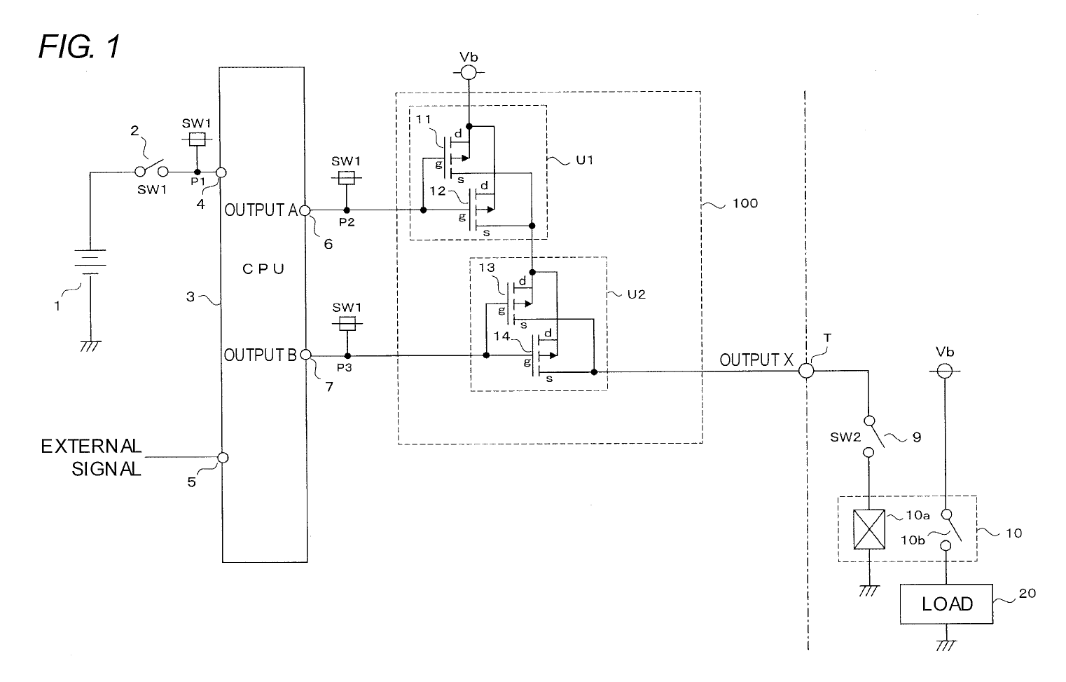

Referring to FIG. 1, a signal output circuit according to one or more embodiments of the present invention is configured by a CPU 3, a switching circuit 100, and an output terminal T. The switching circuit 100 includes a first switching unit U1 having a first switching element 11 and a second switching element 12, and a second switching unit U2 having a third switching element 13 and a fourth switching element 14. Each of the switching elements 11 to 14 is constituted by an FET.

The CPU 3 includes two input ports 4 and 5 and two output ports 6 and 7. The input port 4 is connected to a battery 1, which is a DC power source, through an operation switch 2 (SW1). One end of the operation switch 2 is connected to an anode of the battery 1, and the other end of the operation switch 2 is connected to the input port 4 of the CPU 3. A cathode of the battery 1 is grounded.

The input port 4 of the CPU 3 receives a signal of the operation switch 2. This signal appears at points P1, P2, and P3 at the same time. In FIG. 1, the signal of the operation switch 2 which appears at P1, P2, and P3 is denoted by “SW1” for the sake of convenience. In fact, the points P1, P2, and P3 are electrically connected to one another by a wire pattern on a circuit board. Accordingly, the signal of the operation switch 2 that is input to the input port 4 is simultaneously input to gates g of the first to fourth switching elements 11 to 14.

The input port 5 of the CPU 3 receives an external signal from a host device (not illustrated). The output port 6 outputs a signal (OUTPUT A) to gates g of the first and second switching elements 11 and 12. The output port 7 outputs a signal (OUTPUT B) to gates g of the third and fourth switching elements 13 and 14.

Both drains d of the first switching element 11 and the second switching element 12 are connected to a power source Vb. Both sources s of the first switching element 11 and the second switching element 12 are connected to drains d of the third switching element 13 and the fourth switching element 14. Both gates g of the first switching element 11 and the second switching element 12 are connected to the output port 6 of the CPU 3. Both sources s of the third switching element 13 and the fourth switching element 14 are connected to the output terminal T. Both gates g of the third switching element 13 and the fourth switching element 14 are connected to the output port 7 of the CPU 3. As a result, the first switching unit U1 and the second switching unit U2 are connected in series to each other between the power source Vb and the output terminal T.

As will be described later, the CPU 3 outputs predetermined signals from the output ports 6 and 7, based on a signal of the operation switch 2 input to the input port 4 and an external signal input to the input port 5, thereby turning ON and OFF the switching elements 11 to 14.

The output terminal T is connected to one end of an operation switch 9 (SW2), and the other end of the operation switch 9 is connected to one end of a coil 10a in a relay 10. The other end of the coil 10a is grounded. One end of a contact 10b in the relay 10 is connected to the power source Vb, and the other end of the contact 10b is connected to a load 20. Once a current flows through the coil 10a of the relay 10, the contact 10b is closed and power from the power source Vb is supplied to the load 20. As a result, the load 20 is driven.

In the above configuration, the CPU 3 corresponds to a “controller” in one or more embodiments of the present invention. The input ports 4 and 5 of the CPU 3 correspond to a “first input port” and a “second input port” in one or more embodiments of the present invention, respectively. The output ports 6 and 7 of the CPU 3 correspond to a “first output port” and a “second output port” in one or more embodiments of the present invention, respectively. The drain d, source s, and gate g of each of the switching elements 11 to 14 correspond to a “first electrode”, a “second electrode”, and a “third electrode” in one or more embodiments of the present invention, respectively. The operation switch 2 corresponds to a “first switch” in one or more embodiments of the present invention and the operation switch 9 corresponds to a “second switch” in one or more embodiments of the present invention.

Next, a description will be given of an operation of the signal output circuit illustrated in FIG. 1.

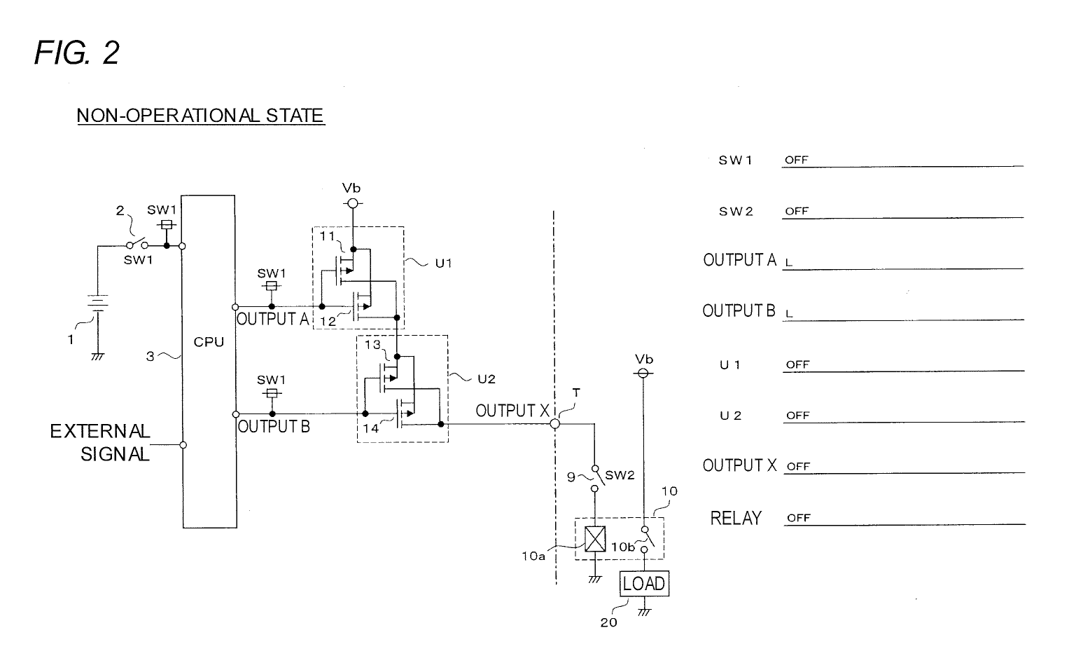

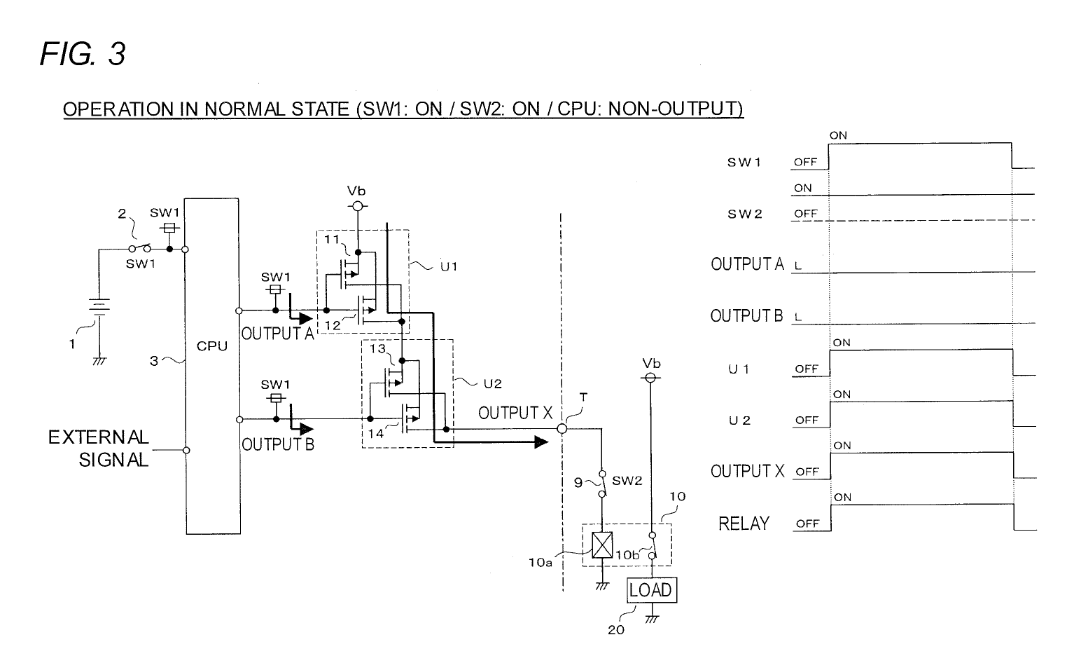

First, a description will be given of an operation of the signal output circuit in a normal state where neither of the switching units U1 and U2 fails. FIG. 2 illustrates a state of the signal output circuit in a non-operational state, and signal waveforms of each unit. In the signal waveforms, “SW1” and “SW2” represent respective signals of the operation switches 2 and 9, and “OUTPUT A” and “OUTPUT B” represent respective outputs from the output ports 6 and 7 of FIG. 1. “U1” and “U2” represent respective ON/OFF states of the switching units U1 and U2, respectively, and “OUTPUT X” represents an output from the output terminal T. “RELAY” represents an ON/OFF state of the contact 10b in the relay 10. The above description also applies to waveforms of FIGS. 3 to 10.

Both SW1 and SW2 are OFF in the non-operational state of FIG. 2. Because no external signal is input to the CPU 3, both OUTPUT A and OUTPUT B are L (low level). Accordingly, both switching units U1 and U2 are in an OFF state, and OUTPUT X is in an OFF state. As a result, no power is supplied to the coil 10a of the relay 10, and therefore, the contact 10b is OFF, so that the load 20 is not driven.

FIG. 3 illustrates a state of the signal output circuit in a normal operational state, and signal waveforms of each unit. In this case, while the operation switch 9 is closed and SW2 is ON, the operation switch 2 gets closed and SW1 is turned ON. Further, no external signal is input to the CPU 3.

In the case of FIG. 3, because a signal of the operation switch 2 is input to the CPU 3 but no external signal is input to the CPU 3, both OUTPUT A and OUTPUT B are L. Then, in response to the turn-on of SW1, the gates of the first switching element 11 and the second switching element 12 and the gates of the third switching element 13 and the fourth switching element 14 become H (high level). Therefore, the switching elements 11 to 14 turn ON, and the switching units U1 and U2 enter an ON state. As a result, power from the power source Vb is supplied to the coil 10a of the relay 10 through the switching units U1 and U2, the output terminal T, and the operation switch 9. In turn, the contact 10b of the relay 10 turns ON, and power from the power source Vb is supplied to the load 20, so that the load 20 is driven.

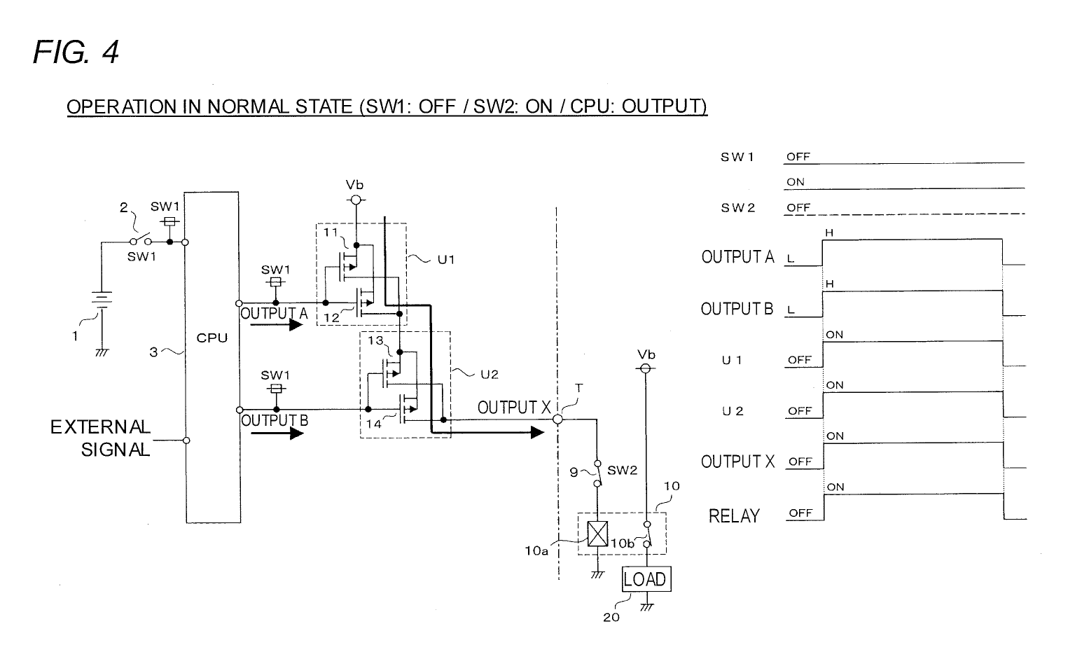

FIG. 4 illustrates another state of the signal output circuit in a normal operational state, and signal waveforms of each unit. In this case, while the operation switch 9 is closed and SW2 is ON, an external signal is input to the CPU 3. Further, the operation switch 2 is opened and SW1 is OFF.

In the case of FIG. 4, because a signal at the operation switch 2 is not input to the CPU 3 but an external signal is input to the CPU 3, the output ports 6 and 7 output respective signals, and both OUTPUT A and OUTPUT B become H. Therefore, all the gates of the switching elements 11 to 14 become H, and the switching units U1 and U2 enter an ON state. As a result, similarly to the case of FIG. 3, power from the power source Vb is supplied to the coil 10a of the relay 10 through the switching units U1 and U2, the output terminal T, and the operation switch 9. In turn, the contact 10b of the relay 10 turns ON, and power from the power source Vb is supplied to the load 20, so that the load 20 is driven.

Next, a description will be given of an operation of the signal output circuit in the case where a failure occurs in which a drain and source of one switching element are kept being short-circuited (ON failure).

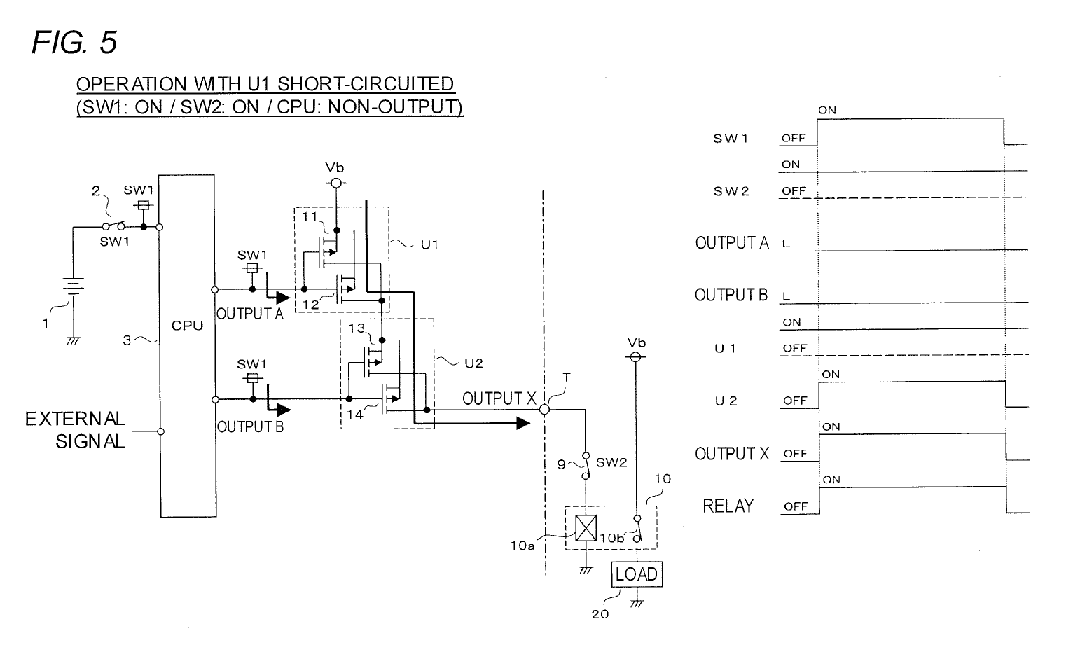

FIG. 5 illustrates a state of the signal output circuit when the first switching unit U1 is short-circuited, namely, when one or both of the first switching element 11 and the second switching element 12 are short-circuited, and signal waveforms of each unit. In this case, while the operation switch 9 is closed and SW2 is ON, the operation switch 2 gets closed and SW1 is turned ON. Further, no external signal is input to the CPU 3.

In the case of FIG. 5, because a signal of the operation switch 2 is input to the CPU 3 but no external signal is input to the CPU 3, both OUTPUT A and OUTPUT B are L. In response to the turn-on of SW1, the gates of the third and fourth switching elements 13 and 14 become H. Therefore, the switching elements 13 and 14 turn ON, and the second switching unit U2 enters an ON state. Meanwhile, in response to the turn-on of SW1, the gates of the first switching element 11 and the second switching element 12 also become H. In this case, because one or both of the switching elements 11 and 12 are short-circuited, the first switching unit U1 is kept ON, regardless of the ON/OFF state of SW1. However, because the second switching unit U2 is in the normal state and turns ON/OFF in synchronization with the ON/OFF state of SW1, OUTPUT X at the output terminal T enters an ON state in response to the turn-on of SW1. As a result, power from the power source Vb is supplied to the coil 10a of the relay 10 through the switching units U1 and U2, the output terminal T, and the operation switch 9. In turn, the contact 10b of the relay 10 turns ON, and power from the power source Vb is supplied to the load 20, so that the load 20 is driven.

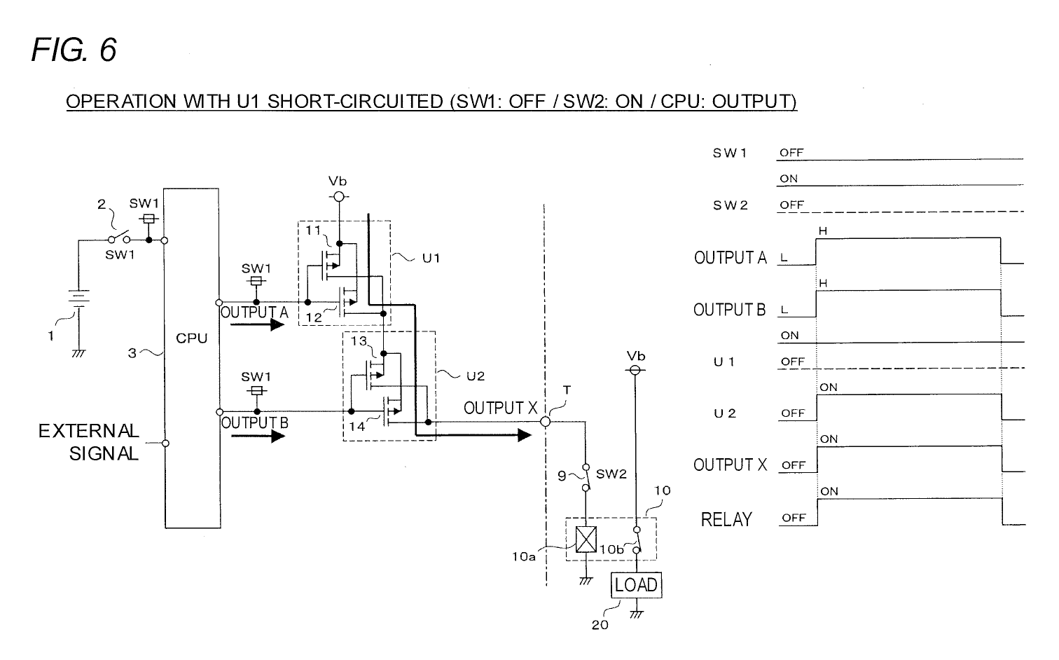

FIG. 6 illustrates another state of the signal output circuit when the first switching unit U1 is short-circuited, and signal waveforms of each unit. In this case, while the operation switch 9 is closed and SW2 is ON, an external signal is input to the CPU 3. Further, the operation switch 2 is opened and SW1 is OFF.

In the case of FIG. 6, because a signal of the operation switch 2 is not input to the CPU 3 but an external signal is input to the CPU 3, the output ports 6 and 7 output respective signals and both OUTPUT A and OUTPUT B are H. In response to H at OUTPUT B, the third and fourth switching elements 13 and 14 turn ON, and the second switching unit U2 enters an ON state. Meanwhile, because one or both of the switching elements 11 and 12 are short-circuited, the first switching unit U1 is kept ON, regardless of the H/L state of OUTPUT A. In this case, because the second switching unit U2 is in the normal state and turns ON/OFF in synchronization with the H/L state of OUTPUT B, OUTPUT X at the output terminal T enters an ON state in response to H at OUTPUT B. As a result, power from the power source Vb is supplied to the coil 10a of the relay 10 through the switching units U1 and U2, the output terminal T, and the operation switch 9. In turn, the contact 10b of the relay 10 turns ON, and power from the power source Vb is supplied to the load 20, so that the load 20 is driven.

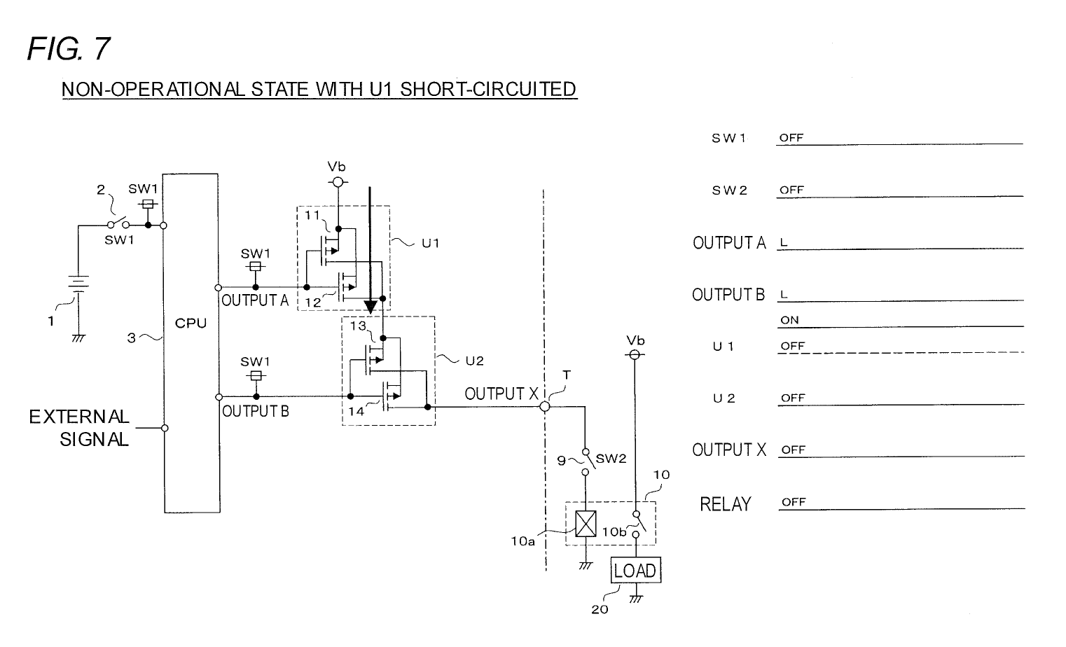

FIG. 7 illustrates a state of the signal output circuit in a non-operational state when the first switching unit U1 is short-circuited, and signal waveforms of each unit. Further, both operation switches 2 and 9 are opened, and both SW1 and SW2 are OFF. In addition, no external signal is input to the CPU 3, and both OUTPUT A and OUTPUT B are L.

In the case of FIG. 7, the first switching unit U1 in the short-circuited state is kept in the ON state, but the second switching unit U2 in the normal state is OFF. Therefore, no current path is established from the first switching unit U1 to the output terminal T through the second switching unit U2. Thus, OUTPUT X at the output terminal T is maintained in an OFF state. In addition, because the operation switch 9 is also OFF, no power is supplied to the coil 10a of the relay 10.

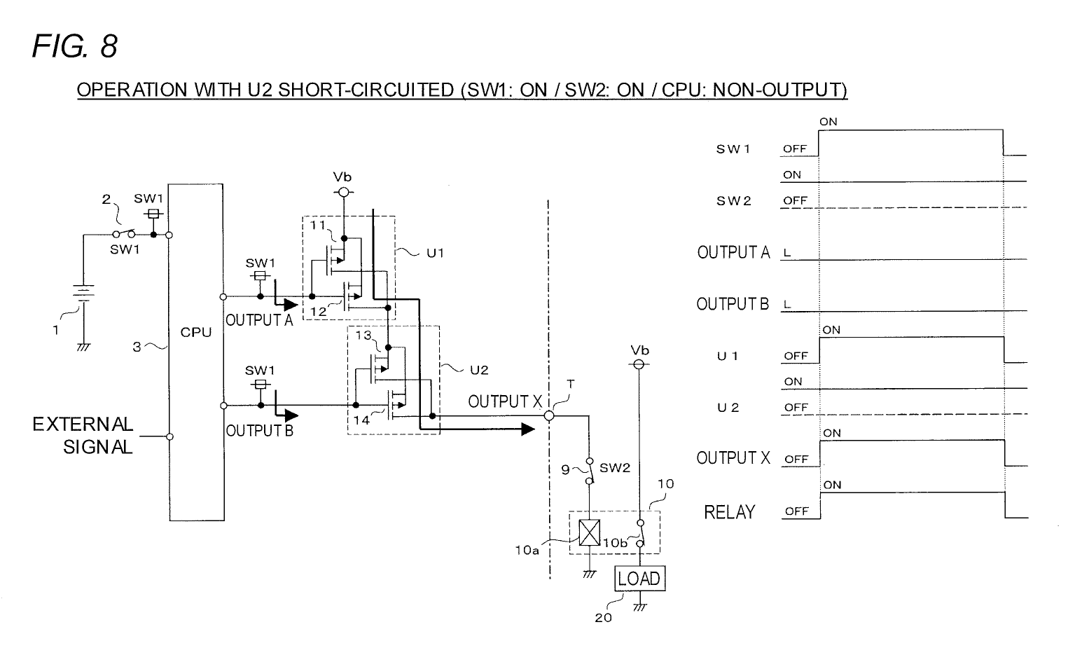

FIG. 8 illustrates a state of the signal output circuit when the second switching unit U2 is short-circuited, namely, when one or both of the third and fourth switching elements 13 and 14 are short-circuited, and signal waveforms of each unit. In this case, while the operation switch 9 is closed and SW2 is ON, the operation switch 2 gets closed and SW1 is turned ON. Further, no external signal is input to the CPU 3.

In the case of FIG. 8, because a signal of the operation switch 2 is input to the CPU 3 but no external signal is input to the CPU 3, both OUTPUT A and OUTPUT B are L. Then, in response to the turn-on of SW1, the gates of the first and second switching elements 11 and 12 become H. Therefore, the switching elements 11 and 12 turn ON, and the first switching unit U1 enters an ON state. Meanwhile, in response to the turn-on of SW1, the gates of the third and fourth switching elements 13 and 14 become H. However, because one or both of the third and fourth switching elements 13 and 14 are short-circuited, the second switching unit U2 is kept in an ON state, regardless of the ON/OFF state of SW1. Therefore, because the first switching unit U1 is in a normal state and turns ON/OFF in synchronization with the ON/OFF state of SW1, OUTPUT X at the output terminal T enters an ON state in response to the turn-on of SW1. As a result, power from the power source Vb is supplied to the coil 10a of the relay 10 through the switching units U1 and U2, the output terminal T, and the operation switch 9. In turn, the contact 10b of the relay 10 turns ON, and power from the power source Vb is supplied to the load 20, so that the load 20 is driven.

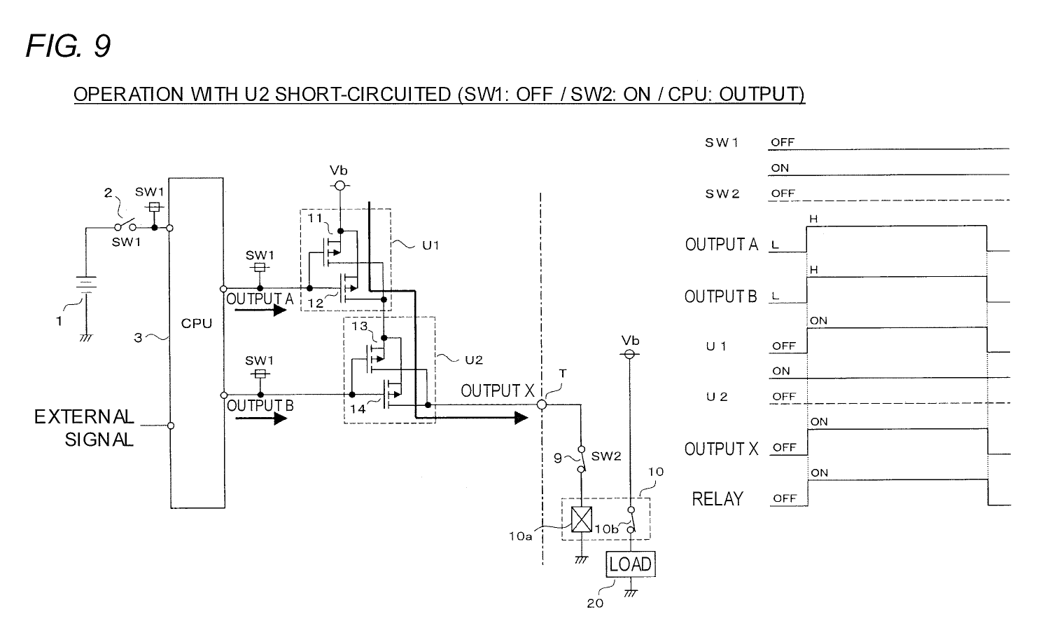

FIG. 9 illustrates another state of the signal output circuit when the second switching unit U2 is short-circuited, and signal waveforms of each unit. In this case, while the operation switch 9 is closed and SW2 is ON, an external signal is input to the CPU 3. Further, the operation switch 2 is opened and SW1 is OFF.

In the case of FIG. 9, because a signal of the operation switch 2 is not input to the CPU 3 but an external signal is input to the CPU 3, signals are output from the output ports 6 and 7, and OUTPUT A and OUTPUT B are H. In response to H of OUTPUT A, the first and second switching elements 11 and 12 turn ON, and the first switching unit U1 enters an ON state. Meanwhile, because one or both of the switching elements 13 and 14 are short-circuited, the second switching unit U2 is kept in an ON state, regardless of the H/L state of OUTPUT B. In this case, because the first switching unit U1 is in a normal state and turns ON/OFF in synchronization with the OUTPUT A, OUTPUT X at the output terminal T enters an ON state in response to H of OUTPUT A. As a result, power from the power source Vb is supplied to the coil 10a of the relay 10 through the switching units U1 and U2, the output terminal T, and the operation switch 9. In turn, the contact 10b of the relay 10 turns ON, and power from the power source Vb is supplied to the load 20, so that the load 20 is driven.

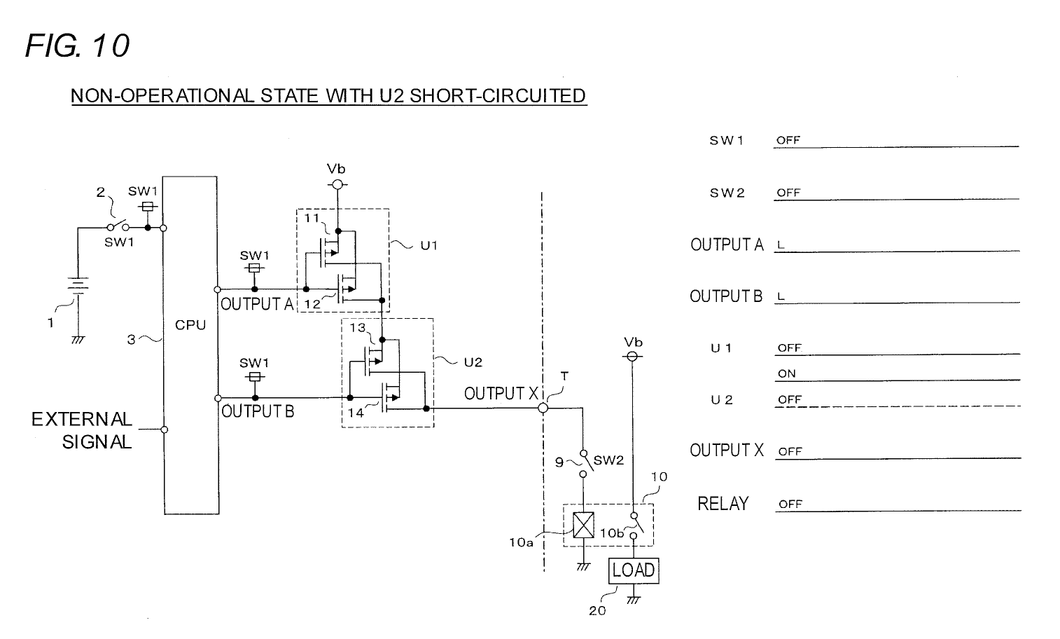

FIG. 10 illustrates a state of the signal output circuit in a non-operational state when the second switching unit is short-circuited, and signal waveforms of each unit. Both operation switches 2 and 9 are opened, and both SW1 and SW2 are OFF. Further, no external signal is input to the CPU 3, and both OUTPUT A and OUTPUT B are L.

In the case of FIG. 10, the second switching unit U2 in the short-circuited state is kept in an ON state, but the first switching unit U1 in a normal state is OFF. Accordingly, no current path is established from the first switching unit U1 to the output terminal T through the second switching unit U2. Thus, OUTPUT X at the output terminal T is maintained in an OFF state. In addition, because the operation switch 9 is also OFF, no power is supplied to the coil 10a of the relay 10.

As described above, in the above one or more embodiments, even when the first switching unit U1 is short-circuited, as long as the second switching unit U2 is in a normal state, the relay 10 operates normally. Likewise, even when the second switching unit U2 is short-circuited, as long as the first switching unit U1 is in a normal state, the relay 10 operates normally.

In the above one or more embodiments, each of the switching units U1 and U2 employs a double structure formed of a pair of switching elements. Accordingly, even when one of the switching elements 11 and 12 in the first switching unit U1 fails and is kept in an opened state (OFF failure), the first switching unit U1 outputs a normal signal as long as the other switching element is in a normal state. Likewise, even when one of the switching elements 13 and 14 in the second switching unit U2 fails and is kept in an opened state (OFF failure), the second switching unit U2 outputs a normal signal as long as the other switching element is in a normal state.

In this manner, as described in the above one or more embodiments, the signal output circuit can output a normal signal in accordance with an input signal, even when part of the circuit fails. Accordingly, the safety and reliability of the signal output circuit that is driving the load 20 can be improved.

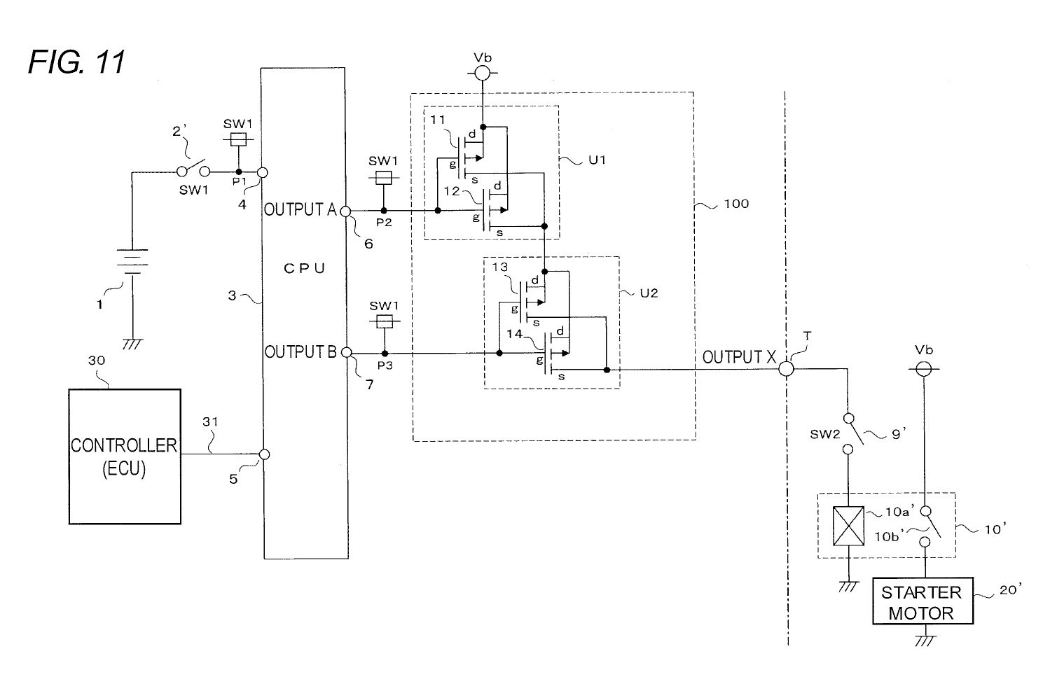

In the above description, a general-purpose signal output circuit has been exemplified. However, a signal output circuit according to one or more embodiments of the present invention is also applicable to a starter motor driving circuit in an automobile, such as that described at the beginning part. FIG. 11 illustrates a starter motor driving circuit according to one or more embodiments of the present invention regarding this case.

Referring to FIG. 11, a controller (ECU; Electronic Control Unit) 30 as a host device is added to the configuration of FIG. 1. Furthermore, the operation switch 2, the operation switch 9, the relay 10, and the load 20 of FIG. 1 are replaced by a starter switch 2′, a shift position switch 9′, a starter relay 10′, and a starter motor 20′, respectively. A coil and a contact in the starter relay 10′ are denoted by reference numerals 10a′ and 10b′, respectively. The CPU 3, the switching circuit 100, the starter switch 2′, the shift position switch 9′, and the starter relay 10′ configure a starter motor driving circuit.

The starter switch 2′ is a switch that operates to actuate the starter motor 20′. The starter motor 20′ is a motor that actuates the engine of an automobile. The shift position switch 9′ is a switch that turns ON and OFF in accordance with a position of the shift lever (such as parking, neutral, or drive position) (not illustrated), provided in the driver's seat. For example, while the shift lever is at the parking (P) or neutral (N) position, the shift position switch 9′ is ON. Meanwhile, while the shift lever is at the drive (D) position, the shift position switch 9′ is OFF.

The controller 30 is connected to the input port 5 of the CPU 3 through a CAN (Controller Area Network) communication cable 31. Examples of the controller 30 include various types of control units, such as an engine control unit or an in-vehicle part control unit.

Next, an operation of the starter motor driving circuit of FIG. 11 will be described by way of examples.

For example, it is assumed that a user turns ON the starter switch 2′ in a vehicle stopping with the shift lever being at the parking position, in order to actuate the engine. In this case, the operation of the starter motor driving circuit is as follows.

As described above, while the shift lever is at the parking position, the shift position switch 9′ is ON. Then, once the starter switch 2′ is turned ON, operations that are the same as those described with reference to FIG. 3 are performed.

Specifically, because no external signal is input to the CPU 3 in this case, both OUTPUT A and OUTPUT B are L. Then, in response to the turn-on of the starter switch 2′ (SW1), the gates of the switching elements 11 to 14 become H. Therefore, the switching elements 11 to 14 turn ON, whereby the switching units U1 and U2 enter an ON state. As a result, power from the power source Vb is supplied to the coil 10a′ of the starter relay 10′ through the switching units U1 and U2, the output terminal T, and the shift position switch 9′. In turn, the contact 10b′ of the starter relay 10′ turns ON, and power from the power source Vb is supplied to the starter motor 20′. Finally, the starter motor 20′ is driven, so that the engine is actuated.

Further, for example, it is assumed that a user steps on the brake pedal in a vehicle stopping with the shift lever being at the parking position, in order to change the position of the shift lever. In this case, an operation of the starter motor driving circuit is as follows.

As described above, while the shift lever is at the parking position, the shift position switch 9′ is ON. Then, once the user steps on the brake pedal, a brake ON signal is input from the controller 30a to the CPU 3. As a result, operations that are the same as those described with reference to FIG. 4 are performed.

Specifically, once a brake ON signal as an external signal is input from the controller 30 to the CPU 3, through the CAN communication cable 31, the CPU 3 outputs H signals to the output ports 6 and 7. In response, the switching elements 11 to 14 turn ON, whereby the switching units U1 and U2 enter an ON state. As a result, power from the power source Vb is supplied to the coil 10a′ of the starter relay 10′ through the switching units U1 and U2, the output terminal T, and the shift position switch 9′. In turn, the contact 10b′ of the starter relay 10′ turns ON, and then, power from the power source Vb is supplied to the starter motor 20′. Finally, the starter motor 20′ is driven, so that the engine is actuated.

The above description applies to an operation of the starter motor driving circuit in the normal state. Meanwhile, operations of the starter motor driving circuit of FIG. 11 with one of the switching units U1 and U2 being short-circuited is the same as those of FIGS. 5 to 10. Accordingly, a description thereof will be omitted.

In one or more embodiments of the present invention, various modifications may be adopted other than the above-described embodiments. For example, FETs have been given as examples of the switching elements 11 to 14 of the switching circuit 100 in the above embodiments. However, typical transistors may be used instead of FETs. In this case, a collector, emitter, and base of a transistor correspond to the first, second, and third electrodes, respectively.

In the above embodiments, the relay 10 (the starter relay 10′) has been given as an example of an opening-closing element that controls the supply or shutdown of power to the load 20 (the starter motor 20′). However, a large capacity semiconductor switching element, such as an insulated gate bipolar transistor (IGBT), may be used instead of a relay.

In the above embodiments, the operation switch 2 (the starter switch 2′) and the operation switch 9 (the shift position switch 9′), each of which is a mechanical switch, have been given as examples of the first and second switches, respectively. However, each of the first and second switches may be configured by an electronic switch instead of a mechanical switch.

In FIG. 11, the starter motor driving circuit to be built in an automobile is illustrated as an example. However, a signal output circuit according to one or more embodiments of the present invention may be applied to various applications, other than the starter motor driving circuit.

While the invention has been described with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

1. A signal output circuit comprising:
a switching circuit comprising a first switching unit and a second switching unit;
a controller controlling the first switching unit and the second switching unit in the switching circuit; and
an output terminal outputting a predetermined signal based on an operation of the switching circuit,
wherein the first switching unit has a first switching element and a second switching element,
wherein the second switching unit has a third switching element and a fourth switching element,
wherein each of the first switching element and the second switching element has a first electrode connected to a power source,
wherein each of the first switching element and the second switching element has a second electrode connected to first electrodes of the third switching element and the fourth switching element,
wherein each of the first switching element and the second switching element has a third electrode connected to a first output port of the controller,
wherein each of the third switching element and the fourth switching element has a second electrode connected to the output terminal, and
wherein each of the third switching element and the fourth switching element has a third electrode connected to a second output port of the controller.

2. The signal output circuit according to claim 1, wherein the controller comprises:
a first input port receiving a signal of a first switch, and
a second input port receiving an external signal from a host device,
wherein the controller outputs respective predetermined signals to the first output port and the second output port, based on the signal of the first switch which the first input port has received and the external signal which the second input port has received.

3. The signal output circuit according to claim 2,
wherein the signal of the first switch that is input to the first input port is simultaneously input to the third electrodes of the first switching element and the second switching element and the third electrodes of the third switching element and the fourth switching element.

4. The signal output circuit according to claim 2,
wherein the output terminal is connected to one end of a second switch, and
wherein the other end of the second switch is connected to a coil of a relay.

5. The signal output circuit according to claim 4,
wherein the first switch is a starter switch for a vehicle,
wherein the second switch is a shift position switch for the vehicle, and
wherein the relay is a starter relay for the vehicle.

6. The signal output circuit according to claim 1,
wherein each of the first to fourth switching elements is an FET,
wherein a drain of the FET constitutes the first electrode,
wherein a source of the FET constitutes a second electrode, and
wherein a gate of the FET constitutes a third electrode.

7. The signal output circuit according to claim 3,
wherein the output terminal is connected to one end of a second switch, and
wherein the other end of the second switch is connected to a coil of a relay.

8. The signal output circuit according to claim 2,
wherein each of the first to fourth switching elements is an FET,
wherein a drain of the FET constitutes the first electrode,
wherein a source of the FET constitutes a second electrode, and
wherein a gate of the FET constitutes a third electrode.

9. The signal output circuit according to claim 3,
wherein each of the first to fourth switching elements is an FET,
wherein a drain of the FET constitutes the first electrode,
wherein a source of the FET constitutes a second electrode, and
wherein a gate of the FET constitutes a third electrode.

10. The signal output circuit according to claim 4,
wherein each of the first to fourth switching elements is an FET,
wherein a drain of the FET constitutes the first electrode,
wherein a source of the FET constitutes a second electrode, and
wherein a gate of the FET constitutes a third electrode.

11. The signal output circuit according to claim 5,
wherein each of the first to fourth switching elements is an FET,
wherein a drain of the FET constitutes the first electrode,
wherein a source of the FET constitutes a second electrode, and
wherein a gate of the FET constitutes a third electrode.
